(19) United States
(12) Patent Application Publication
(10) Pub. No.: US 2012/0253495 A1
(43) Pub. Date: Oct. 4, 2012

(54) DEFINING THE VOLUMETRIC DIMENSIONS AND SURFACE OF A COMPENSATOR

(75) Inventors: JOHN M. WRIGHT, Gillingham (GB); William Tomer, Ben Avon, PA (US); Michael J. Hudson, Great Missenden (GB)

(73) Assignee: Axellis Ventures Ltd., Market Harborough (GB)

(21) Appl. No.: 13/077,306

(22) Filed: Mar. 31, 2011

(51) Int. Cl. G06F 19/00; G06F 17/50

(52) U.S. Cl. 700/98

(57) ABSTRACT

A compensator is used with a radiation therapy machine to treat a cancer patient. A three-dimensional surface of the compensator is defined by obtaining a radiation dose requirement created by a treatment planning system associated with the radiation therapy machine and determining a plurality of grid elements based on that radiation dose requirement. At least one of a plurality of points on each of the plurality of grid elements is connected with at least one of the plurality of points on another one of the plurality of grid elements to form a representation of the three-dimensional compensator.

### TECHNICAL FIELD

The invention relates to accurately defining the volumetric dimensions and surface of a compensator (also known as a radiation filter), where the compensator is used with a linear accelerator to treat with radiation a cancerous tumor of a patient.

### BACKGROUND INFORMATION

Intensity-modulated radiation therapy (IMRT) is a treatment method for accurately delivering a defined and uniform dose of radiation to a tumor site. This treatment method is designed to limit the amount of radiation to which peripheral non-cancerous tissues and structures are exposed. IMRT is used on cancer patients to deliver a uniform dose of radiation to a patient's cancerous tissue as defined by the clinician while avoiding, or at least minimizing, radiation exposure to the surrounding healthy or critical body structures of the patient. IMRT delivers radiation to the patient's cancerous tissue from various angles and at various intensity levels in order to achieve the prescribed dose profile for that patient. Patients with cancer can be treated with other types of radiation therapy such as proton radiation therapy or cobalt radiation therapy.

With IMRT and other types of radiation therapy, the intensity of the radiation beam can be varied or modulated by using a compensator. A compensator is also known as a radiation filter. The compensator is mounted directly in the path of a radiation beam generated by a radiation therapy machine, before the beam reaches the patient. Each compensator is made specifically for a particular patient and also for each angle (field) from which radiation is delivered. Existing practice utilizes compensators machined from a solid piece of material. The unique patient-specific three-dimensional geometry of each machined finished compensator provides the conformal radiation dose distributions required by that particular cancer patient to treat their tumor according to the prescribed dose. In general, a compensator created for one cancer patient cannot effectively be used for the treatment of another cancer patient. Individual compensators are used from each beam angle (field) during a course of IMRT treatment, requiring a change of compensator for each discrete field of radiation treatment. Compensators are typically provided in “sets” for a treatment plan for a specific patient.

Patient-specific compensators can be machined in-house at a hospital or other radiation treatment facility, or the compensators can be ordered from a 3^{rd} party supplier such as an outside machine shop. One outside machine shop from which compensators can be ordered is .decimal, Inc of Sanford, Fla. (www.dotdecimal.com). After manufacturing the ordered compensator, the outside machine shop physically delivers that set of compensators to the requesting treatment facility, typically by shipping it to the facility using a general carrier.

### SUMMARY OF THE INVENTION

The results of a computed tomography (CT) scan, or a magnetic resonance imaging (MRI) scan, that is performed on a cancer patient (as ordered by the patient's oncologist, for example) may indicate the need for localized radiation therapy on the patient. If so, the scan data are entered into a treatment planning system (TPS). The TPS executes one or more software applications that map and determine precise radiation beam density needed to aim at the target area of the patient from each of a variety of angles or positions around the patient and thus to treat the patient's specific cancerous tumor. Each of the various beam densities can be referred to as a radiation dose requirement and also as a fluence pattern or a fluence map. The TPS can provide each of these fluence patterns for the patient in a computer-readable file that may be referred to as a dose description file or a fluence file. The data contained in each of these files represent the patient's fluence pattern for a particular radiation beam orientation, and the data can be processed by a computer to determine and define mathematically the three-dimensional surface of the compensator needed for use with a linear accelerator to deliver the proper radiation from the accelerator to the cancer patient for that particular orientation or angle of the accelerator's beam. The invention relates to particular processing done with data presented by a dose description file or a fluence file to arrive at an extremely accurate mathematical representation of the required compensator three-dimensional surface. This highly accurate model of the needed compensator can be used to create a physical real-world compensator that agrees more closely with the original TPS-determined fluence map as compared to physical compensators created from conventional computer models of compensator three-dimensional surfaces.

The dose description file or fluence file can be considered an array of planar cells (rows and columns) dividing up the treatment area as a regular grid of a defined size. A conventional way to build a model of a compensator surface from a TPS-generated fluence file is to take a point at the center of each cell in a row-by-row (or column-by-column) basis, apply a depth relating to the amount of radiation required at that cell, and perform a join-the-dots routine. The depth is calculated by computing the amount of radiation required at the cell, factoring in variables such as the attenuation properties of the compensator material, position of compensator, and linear accelerator beam properties. This conventional approach can involve a series of straight lines or a curve fit. In essence, the conventional approach provides an infinitesimally small point of radiation dose being delivered that matches the original TPS-determined fluence map. The conventional approach also commonly involves a radiation physics team re-iterating the design and dose process a number of times until the team achieves a compensator design that is a better approximation of the original TPS-determined fluence map for the cancer patient. In sharp contrast to the conventional approach, the invention relates to building a computer model of a compensator three-dimensional surface from a TPS-generated file by taking a plurality of points (such as, for example, four points, three points, or two points) on each cell and joining these to the adjacent cells to produce a defined (typically “smoother”) transition from one cell to the next. The inventive approach results in a compensator that more accurately reflects the prescribed radiation dose densities within each and every cell, and also a compensator that is easier for machining due to less abrupt transitions across the surface model. The invention results in physical compensators that, when used with a linear accelerator to treat a patient, expose the patient to minimal general radiation while still effectively treating the patient's tumor, cause fewer hot spots in the patient's irradiated tissue, provide better radiation homogeneity across the patient's tumor, and provide sharper fall-offs between high and low dose regions, all as compared to conventionally-produced compensators.

In one aspect, the invention relates to a method of extracting data from one or more files provided by a TPS, where the contents of the file(s) represent the required radiation treatment of a cancer patient. The method comprises obtaining a radiation dose requirement created by the TPS associated with a radiation therapy machine and determining a plurality of grid elements based on the radiation dose requirement. The position of the compensator within the radiation beam and the performance characteristics of the radiation beam as measured through the attenuating medium chosen for the compensator are used to resolve a plurality of three dimensional coordinate points at each cell position described by the originating TPS file. That is, the three-dimensional points that define the compensator are calculated, and then this array of points are joined to create a tessellated surface. Calculating the three-dimensional points that define the compensator can be understood as over-sampling the data to create multiple points at each cell.

In another aspect, the invention relates to a method of defining a volume and surface of a compensator. The compensator is for use in a radiation therapy machine to treat a cancer patient. The method comprises obtaining a radiation dose requirement created by a treatment planning system associated with the radiation therapy machine and determining a plurality of grid elements based on the radiation dose requirement. At least one of a plurality of points on each of the plurality of grid elements is connected with at least one of the plurality of points on another one of the plurality of grid elements to form a representation of the three-dimensional compensator.

Embodiments according to this other aspect of the invention can have various features. For example, the step of obtaining the radiation dose requirement can comprise obtaining a fluence file created by the treatment planning system. And the identifying step can comprise identifying four points one each of the plurality of grid elements. In general, any number of points greater than one can be used for each of the grid elements. The method can also comprise applying a smoothing algorithm to the representation. And the method can further comprise producing the compensator with the three-dimensional surface based on the representation. The compensator can be produced by providing the representation to a computer-aided design and manufacturing (CAD/CAM) system which controls a machine tool to machine the compensator with the three-dimensional surface or which controls a three-dimensional printing system to make the compensator with the three-dimensional surface. The produced compensator can be used in intensity modulated radiation therapy (IMRT), proton radiation therapy, or cobalt radiation therapy. The representation of the three-dimensional surface of the compensator can be a negative impression of the three-dimensional surface of the compensator or it can be a positive impression of the three-dimensional surface of the compensator. If a negative impression, it can be used to produce a receptacle for receiving radiation-attenuating solid particulates, and these particulates can be crystalline tungsten powder. If a positive impression, it can be used to produce the compensator with the three-dimensional surface from a solid piece of radiation-attenuating material such as a solid piece of tungsten, aluminum, brass, machinable wax, or low-density polymer-based resin material such as polycarbonate.

Objects, advantages, and details of the invention herein disclosed will become apparent through reference to the following description, the accompanying drawings, and the claims. The various disclosed embodiments as well as each of the various features of those embodiments are not mutually exclusive and can exist in various combinations and permutations whether or not expressly pointed out in the following description or the accompanying drawings.

### BRIEF DESCRIPTION OF THE DRAWINGS

In the drawings, like structures are referenced by the same or similar reference numbers throughout the various views. The illustrations in the drawings are not necessarily drawn to scale, the emphasis instead being placed generally on illustrating the principles of the invention and the disclosed embodiments.

FIG. 1 is a block diagram showing the entities involved in defining, creating, and validating compensators for use with radiation therapy machines to treat cancer patients.

FIGS. 2A and 2B illustrate a new approach to defining a three-dimensional surface of a compensator from a TPS-generated fluence file.

FIGS. 2C and 2D illustrate a conventional approach to creating a model of a compensator from a fluence file generated by a treatment planning system (TPS).

FIGS. 3A and 3B, like FIGS. 2C and 2D, also illustrate the conventional approach to creating a model of a compensator from a fluence file generated by a TPS.

FIGS. 3C and 3D, like FIGS. 2A and 2B, also illustrate the new approach to defining a three-dimensional surface of a compensator from a TPS-generated fluence file.

### DESCRIPTION

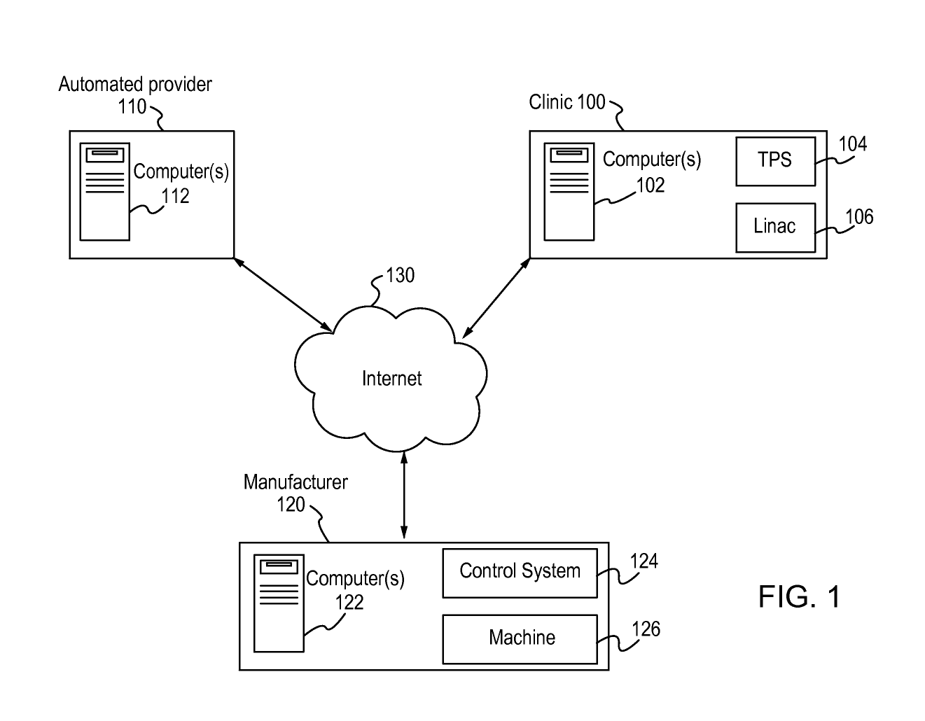

As shown in FIG. 1; the entities involved in defining, manufacturing, and creating patient-specific compensators for use with a radiation therapy machine at a radiation treatment clinic to treat a particular cancer patient include the clinic 100, an outside provider 110, and a manufacturer 120 such as a machine shop. The clinic 100 can be referred to as a radiation oncology treatment center, and it can be a hospital or any location where cancer patients are treated with radiation to address their cancerous tumors. Each clinic 100 typically will have at least one radiation therapy machine such as a linear accelerator 106 and also have access to at least one supporting treatment planning system (TPS) 104. The linear accelerator 106 is also referred to as a “Linac”. Linacs are available commercially from Varian Medical Systems, Inc. (of Palo Alto, Calif.) and also from Siemens Medical Solutions USA, Inc. (of Malvern, Pa.), for example. The TPS 104 is available commercially from Varian under the name “Eclipse” and also from other vendors which use other product names for their treatment planning systems. The clinic 100 typically also will have at least one computer 102 such as a general purpose desktop computer with the typical components including at least one processor, memory (such as RAM and/or ROM), one or more other storage mechanisms or devices (hard drive, for example), at least one display screen, one or more input devices such as a keyboard and/or a mouse, a web browser application such as “Internet Explorer” by Microsoft Corporation of Redmond, Wash., and in general the ability to store instructions in the memory and/or storage devices (more generally, computer-readable media) that are executed by the processor(s) to cause the processor, and thus the computer 102, to perform various functions such as web browser functions as well as other functions. A user of the computer 102 can access the World Wide Web via the Internet 130 by launching and using the computer's web browser. Someone at the clinic 100, or associated with the clinic 100, also could use the TPS 104 to access the Web via the Internet 130 by launching and using a web browser that the TPS 104 might have. As is typical, the Internet 130 is represented in FIG. 1 as a “cloud” which is a metaphor for the Internet. The cloud 130 can be any type of computer or communications network but in the disclosed embodiment is the Internet. Someone at the clinic 100, or associated with the clinic 100, can use the computer(s) 102 to communicate over the network 130 with one or more server computers 112 located at the outside provider 110. The computer(s) 112 can be one or more web servers and/or other types of computers such as application servers. With the computer(s) 112, the provider 110 can communicate via the network 130 with the clinic 100 and also with the manufacturer 120. (While the one or more servers 112 are shown located at the provider 110, it is noted that they do not have to be physically at the same geographic location of the provider 110, and instead one or more or all of the servers 112 could be located at some location remote from the provider 110. That is, some or all of the services and functions performed by the provider 110 could be outsourced or hosted on one or more servers 112 located remote from the business address of the provider 110.) One or more of the computer(s) 112 can execute a computer aided manufacturing (CAM) system, sometimes referred to as a CAD/CAM system (where CAD stands for computer aided design), such as the commercially available piece of software called SurfCAM by Surfware, Inc. of Camarillo, Calif. 93012 (www.surfware.com) or another CAM or CAD/CAM software application available from another software vendor. The manufacturer 120 includes at least one computer 122 and equipment to create one or more physical compensators and/or one or more physical molds into which solid particulates (such as crystalline tungsten powder) can be compacted to form compensators. Any compensator-creating and mold-creating equipment located at the manufacturer 120 can include at least one machine control system 124 and at least one controllable machine 126 such as a computer numerical Control (CNC) machine. The machine 126 can be, for example, a three-axis CNC machine available from Haas Automation, Inc. of Oxnard, Calif. (www.haascnc.com). The machine control system 124 can be a CAD/CAM or a CAM system, and it can calculate CNC tool paths. Once one or more physical patient-specific compensators are created at the manufacturer 120, they can be shipped from the manufacturer 120 to the clinic 100 where they can be used, after validation, with the Linac 106 at the clinic 100 to treat the cancer patient for whom the compensators were made. If the manufacturer 120 has created patient-specific molds as opposed to finished compensators, the molds can be shipped to the clinic 100 and compacted with particulates at the clinic 100 to form finished compensators (as disclosed in US patent application Ser. No. 13/075,885 filed on Mar. 30, 2011), and these types of mold-based compensators then can be used, after validation, with the Linac 106 at the clinic 100 to treat the cancer patient. The entirety of US patent application Ser. No. 13/075,885 is incorporated herein by reference.

The radiation treatment regime for a cancer patient typically is determined by the patient's oncologist and/or the clinical oncology staff at the clinic 100. The oncologist and/or the staff establish the appropriate radiation dose to treat the patient's tumor. This established radiation dose is divided into a number of discrete deliveries, or beams, around the tumor in order to avoid over-dosing critical non-cancerous structures of the patient. The sum total of the beams being the total radiation delivery for the patient's treatment per day; the full course of treatment might take as many as 45 days to complete, for example. Using the TPS 104 configured with the specific radiation characteristics of the target treatment Linac 106, the clinical team imports computed tomography or CT images (sometimes also referred to as CT scans or computerized axial tomography or CAT images or scans) or similar images such as MRI scans taken of the patient's tumor and surrounding structures, adds geometric profiles (boundaries) determining the areas to treat (and the areas to avoid), and enters the radiation dose required into the TPS 104. The TPS 104 then calculates the dose patterns for each beam. Typically, each of the dose patterns can be considered a grid of regularly shaped cells with each cell containing a value between 1 and 0, where 1 represents the maximum dose and 0 represents no radiation dose at all. The non-zero areas of a dose pattern are together referred to as the modulated zone. The dose pattern is also referred to as a fluence pattern or a fluence map. For Intensity Modulated Radiation Therapy (IMRT), the Linac's 106 radiation beam needs to be modulated to create the necessary dose patterns to treat the cancer patient, and this is why compensators are created and used. Each compensator is designed and created to attenuate or modulate the radiation beam to provide the necessary amount of radiation to each of the cells in the grid of a fluence map.

There are actually two ways to modulate the radiation beam of the Linac 106. One way is by using a Multi Leaf Collimator (MLC), and this involves a set of “fingers” that are automatically and programmatically driven into and out of the radiation beam's path to vary the amount of radiation. Another way is by placing in the beam's path a contoured block, and such a block is referred to as a compensator. It typically is, at least initially, more expensive to use an MLC to achieve the necessary modulated zone, because a Linac 106 with an MLC is more expensive than a Linac 106 that uses compensators. To provide the patient with that day's radiation treatment, each compensator of a set of patient-specific compensators is placed at the appropriate time in a frame of the Linac 106 called the accessory mount. When in place, the head of the Linac 106 is rotated to the appropriate beam position and the amount of radiation determined by the TPS 104 is delivered. The compensator is then replaced for the next in the beam sequence, and the process is repeated until all beams have been delivered to provide the patient with his or her radiation treatment for that day.

The TPS 104 can provide each of the fluence maps for a particular cancer patient in a computer-readable file referred to as a dose description file or a fluence file. One common format for such a file is defined by the DICOM (Digital Imaging and Communications in Medicine) standard. The data contained in each of these files represent the patient's fluence pattern for a particular radiation beam orientation, and the data can be processed by a computer, such as the computer(s) 112, to determine and define mathematically the three-dimensional surface of the compensator needed for use with the linear accelerator 106 to deliver the proper radiation from the accelerator 106 to the cancer patient for that particular position, orientation, or angle of the accelerator's beam. The invention relates to particular processing done by the computer(s) 112 with data in a fluence file to arrive at an extremely accurate mathematical representation of the required compensator three-dimensional surface. This highly accurate computer model of the needed three-dimensional compensator surface can be provided to the manufacturer 120, for example, and used directly by the control system 124 and/or the machine 126 at the manufacturer 120 to create a physical real-world compensator that agrees more closely with the original TPS-determined fluence map as compared to physical compensators created from conventional computer models of compensator surfaces. The inventive model also can be provided back to the TPS 104 for use by the TPS 104 to calculate a new fluence map based on the model that was created by the computer(s) 112.

The physical real-world compensator can be produced out of a variety of materials, by the way. For example, the compensator can be formed by the machine 126 (for example, under the control of the control system 124) from a solid piece of radiation-attenuating material such as a solid piece of tungsten, aluminum, brass, machinable wax, or low-density polymer-based resin material such as polycarbonate. Instead of a solid piece of uniform material, the compensator can be formed on the machine 126 from a combined-material blank such as a piece of boron-loaded polyurethane in the shape of a block or having some other shape. And, another possibility is producing the compensator not on the machine 126 but instead by depositing solid particulates into a mold and compacting the particulates sufficiently into the mold, as disclosed in incorporated-by-reference US patent application Ser. No. 13/075,885 filed on Mar. 30, 2011.

The highly accurate computer model of the needed three-dimensional compensator surface that is generated by the computer(s) 112 also could be provided to and used directly by a three-dimensional printing system (located at, for example, the manufacturer 120) to produce the physical real-world compensator. Three-dimensional printing systems are available commercially from Z Corporation of Burlington, Mass. (www.zcorp.com), 3D Systems Corporation of Rock Hill, S.C. (www.3dsystems.com), and Stratasys Inc. of Eden Prairie, Minn. (www.stratasys.com), for example.

Another way to produce the physical real-world compensator is to provide the highly accurate computer model generated by the computer(s) 112 for use directly by a system that can vacuum form a piece of plastic material (such as polycarbonate or acrylonitrile butadiene styrene, ABS) over the required three-dimensional compensator surface to produce the required cavity shape which then could be filled with powdered radiation-attenuating material. The vacuum forming of the material could be done, for example, over a series of pins positioned manually or programmatically where the pin extremity defines the cell position of the corresponding radiation dose requirement.

It is noted that a proton compensator is manufactured from a low density material (for example, about 1 g/cc to 1.2 g/cc, approximately) that is determined by radiation physics preferences at the treatment site. Proton compensators produce a map of the distal end of the tumor in order to define the point in the body where the proton beam gives up its energy. A proton compensator can be defined using the same technique disclosed herein. The defining data in the TPS output files being a discrete z position in the attenuating material. The algorithmic calculations for a proton compensator are achieved directly in the TPS, however, by extracting discrete x,y,z points and then tessellate from those. This is in comparison to how it is done for IMRT, where there is interaction with the TPS file, establishment of the x,y,z data points, and then tessellate from there.

Prior to treating the patient with any radiation, and whether the Linac 106 uses an MLC or compensators, the staff at the clinic 100 is required to check and verify that each beam delivers the radiation as planned by the TPS 104. To do this, a sensitive medium of either film or an electronic dose measurement device is placed on a treatment couch of the Linac 106, and then each beam is delivered and measured with the film or device. When compensators are used, the compensators are mounted to and used with the Linac 106 just as they would be during the actual treatment regime for the patient. The measured radiation delivery is then compared to the new fluence map that was calculated by the TPS 104 based on the highly accurate model of the needed three-dimensional compensator surface that was created by the computer(s) 112. The match could be determined by, for example, meeting or exceeding a comparison threshold such as greater than 80% or greater than 85%.

According to the invention, the one or more computers 112 process the data in a TPS-generated fluence file to arrive at an extremely accurate representation of the required compensator three-dimensional surface, and importantly this representation can be provided to and used directly by both the TPS 104 at the clinic 100 and the control system 124 at the manufacturer 120. The processing performed by the computer(s) 112 on the TPS-generated fluence file involves determining multiple grid elements based on the fluence file, identifying multiple points on each of the grid elements, and connecting at least one of the points on each of the grid elements with at least one point on another one of the grid elements to form the representation of the three-dimensional surface of the compensator. Each grid element can have four points, for example, although it is noted that any number of points-per-grid-element greater than one can be used according to the invention. A smoothing algorithm can optionally be applied to the representation. Further details of the inventive processing are described below.

The invention involves using multiple fluence points for each grid element and also moving the fluence points of each grid element to, or at least somewhat near, the edges of each grid element. The surface model is then calculated from these points. If the points are located exactly at or on the edges of each grid element, the resulting three-dimensional surface model will match exactly the optimized fluence map, but such a model of the three-dimensional surface would only be manufacturable using three-dimensional printing techniques. If the points are located, instead, in from the edges of each grid element, then the resulting three-dimensional surface model will match very well the optimized fluence map and certainly better than when a conventional single-point-per-grid-element technique is used. The invention involves using multiple points on each grid to define an area on each grid element and connecting that points-defined area to the points-defined areas of adjacent grid elements using a tessellation algorithm. Using this method according to the invention, the transitions between grid elements become machinable on standard three-axis CNC machines. It is not conventional to use tessellation from the points on the grid element defined in the fluence map to define the three-dimensional compensator surface without utilizing a traditional CAD/CAM system.

Each point can be smoothened by an averaging kernel. Points with no transmission where there is greater than an N % falloff (where N˜30%) can be ignored. This will retain sharp fall offs but smooth planes of the defined surface. The ability to add smoothening allows very “noisy” fluence maps to be modified slightly to represent a more readily machinable compensator form. The smoothened surface therefore provides the basis of the compensator imported back into the TPS 104 for CNC tool path calculation and for CNC inspection file calculation.

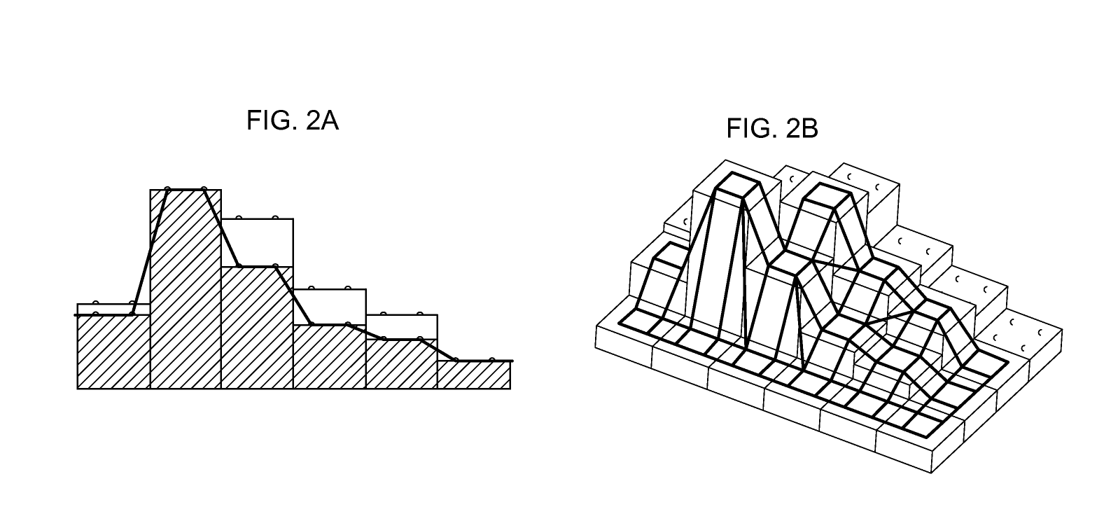

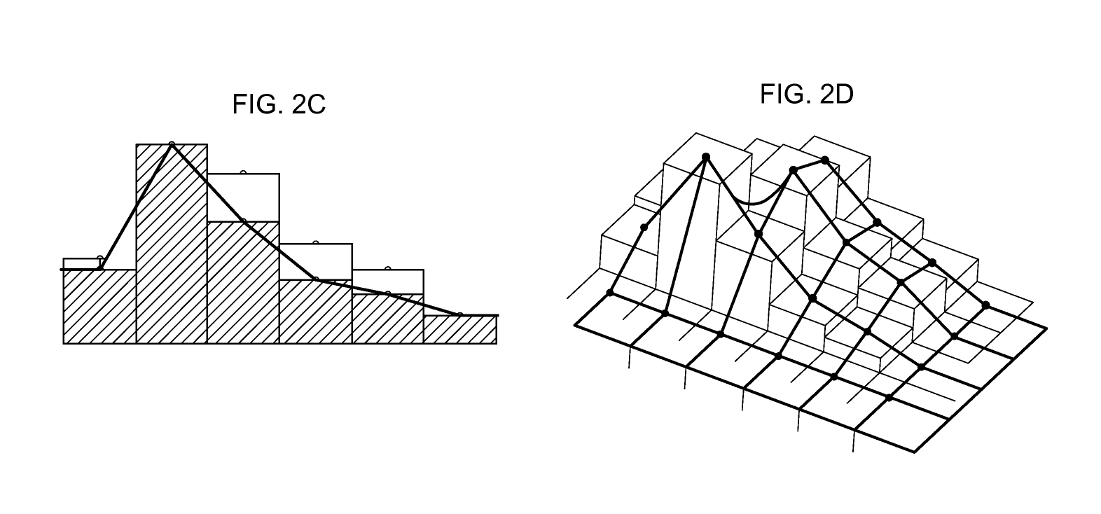

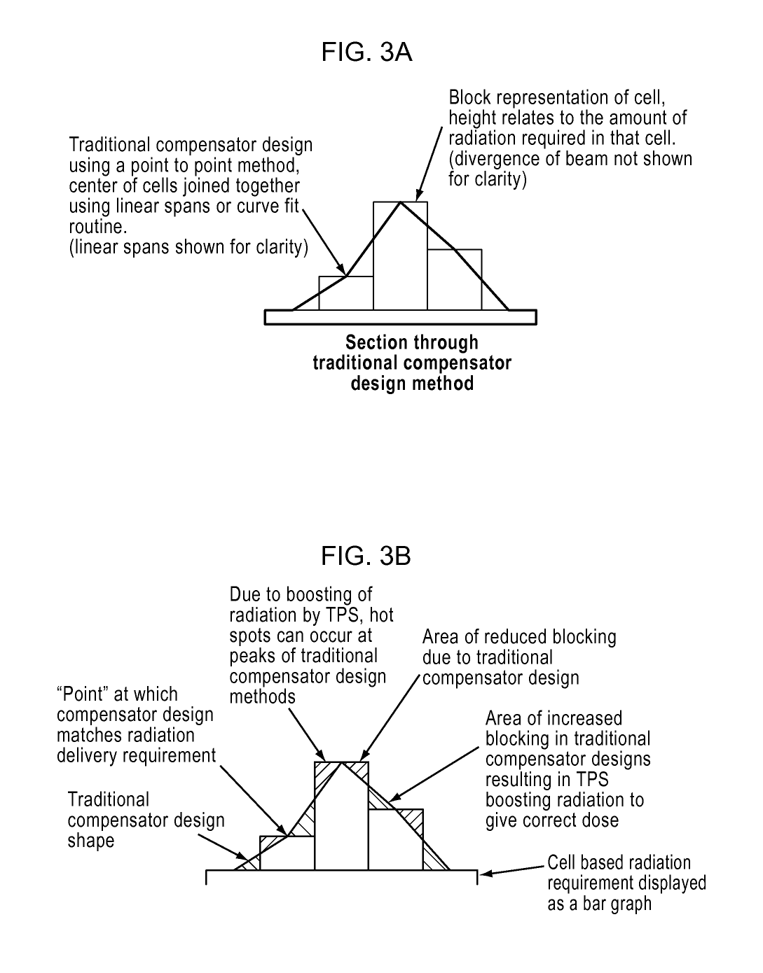

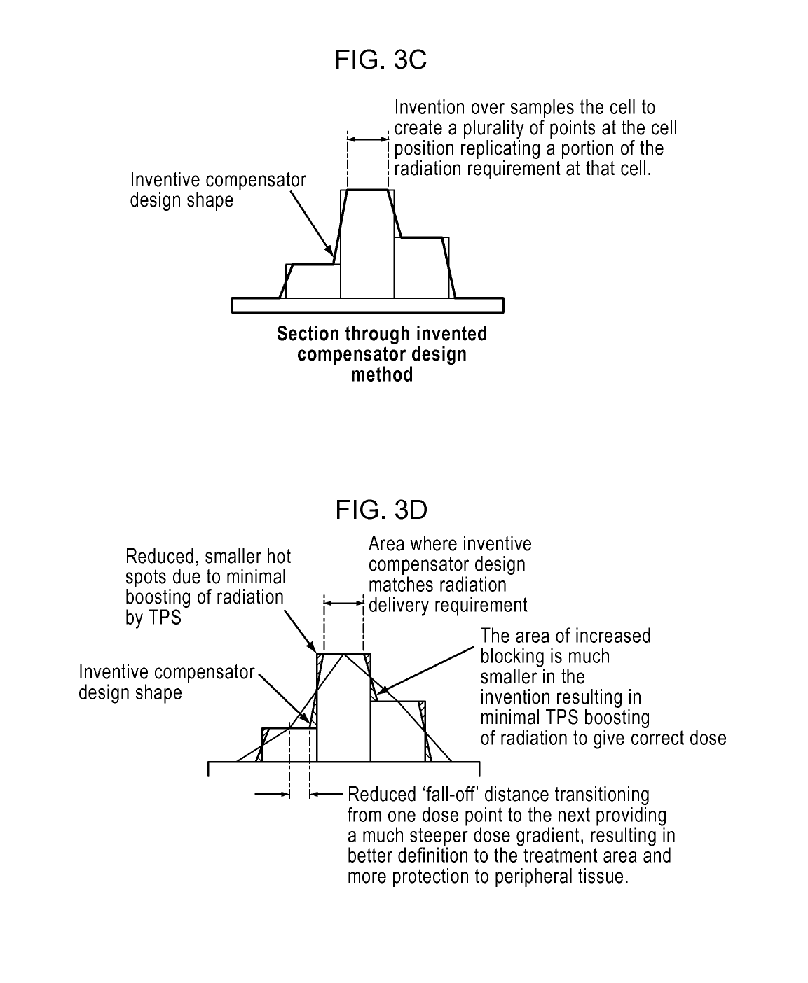

According to the invention, a distinct area representing each cell in a row-by-row (or a column-by-column) basis of the radiation delivery requirement, provided by the TPS, is provided. The conventional way is to take a point at the center of each cell in a row-by-row (or a column-by-column) basis and perform a join-the-dots routine where each successive strip of points joins to the next strip of points. This can be performed as a series of straight lines or as a curve fit. In essence, this provides an infinitesimally small point of radiation dose being delivered that matches the originating radiation requirement plan. This standard approach is illustrated in FIGS. 2A and 2B and also in FIGS. 3A and 3B. The invention, on the other hand, involves over-sampling the data to define a distinct area at each cell by positioning more than one point (for example, four points) on each cell thereby replicating a portion of the radiation dose requirement.

In the situation where the compensator surface is to be produced by removing material from a block (that is, machining), then these points will be calculated in-board of the outer cell boundary. If the compensator is to be produced using 3D printing techniques, the points will be calculated to be at the outer cell boundaries. For manufacture, a surface precisely meeting the plurality of points is created. Each point defined on the cell is joined to multiple points of adjacent cells to form a complete three-dimensional surface of the needed compensator. The surface is available in a format usable by a CAD/CAM system and fully defines the bounding geometry of the compensator with minimal reliance on interpretation by the receiving CAD/CAM system. The surface is further described as a raw unstructured triangulated surface by the unit normal and vertices (ordered by the right hand rule) of the triangles using a three-dimensional Cartesian system. The format was originally presented by 3D Systems, Inc. of Rock Hill, S.C. (www.3Dsystems.com) and takes the general format:

facet normal nᵢ nⱼ nₖ

outer loop

vertex v1ₓ v1_{y} v1_{z}
vertex v2ₓ v2_{y} v2_{z}
vertex v3ₓ v3_{y} v3_{z}

endloop

endfacet

for each facet, thereby presenting a fully defined surface having geometric boundaries to each facet and surface normal indicating the surface direction for each facet. The difference for a compensator machined out of a solid piece of attenuating material (such as brass, aluminum, or tungsten) to that where a mold was produced by machining a cavity into a low density material such as polyurethane or a mold produced on a 3D printer would be the direction indicated by the facet normal statement. Further, each cell defined by the original TPS-generated fluence file is subdivided to present a triangular geometry statement in the format illustrated above. The surface defined by a series of triangles, known in the realm of computer graphics as a tessellated surface and herein referred to as the tessellated surface, can be further analyzed to provide accurate data for any position within the tessellated surface. This analysis includes x,y,z coordinate information and “on”, “inside”, and “outside” information if a selected or required point is on the surface, inside the bounding surface, or outside the surface in free space. This analysis is further used to accurately define the boundary between attenuating material and non-attenuating material when defining the data to be imported into the TPS to define the internal model of the compensator and for defining the surface position for the automated inspection routine. By defining all aspects of the surface used for machining, inspection, and dose calculation, a better agreement with the original radiation dose requirement is achieved due to the replication of a large portion of each cell defining the radiation delivery as shown by FIGS. 2A and 2B and also by FIGS. 3C and 3D. The impact of not using the oversampling technique is shown in FIGS. 2C and 2D and also in FIGS. 3A and 3B, whereby the increased amount of attenuating material may cause the treatment planning system to increase the amount of radiation required to deliver the treatment required by the oncology team. These drawings also show the added impact of increasing the dose in the formation of hot spots in high dose regions. The invention also provides for a more rapid transition between areas of attenuation referred to as the “fall-off”. The steeper fall-off provided by the invention reduces the distance between the treatment zone and the areas where reduced or minimal radiation exposure is required, further improving treatment using the invention. The invention impacts the manufacturing of the compensator by ensuring the designed surface is replicated in the CAM system for manufacture. The same surface is used for machining and inspection enabling automated (that is, no human intervention) inspection routines to be used to accurately define individual positions to be inspected along with their respective pass/fail limits. In treatment terms, the patient is exposed to less radiation during the actual radiation treatment at the clinic 100 with the Linac 106, the patient experiences fewer hot spots, there is better radiation homogeneity across the patient's tumor, and the fall off between the high and low dose regions is steeper which results in a lower margin of adversely impacted non-cancerous tissue of the patient.

Also, from a treatment perspective, FIGS. 2A-2D and 3A-3D together show how the tessellation improves the match of the compensator to the way the radiation beam is modelled by the TPS 104.

Certain embodiments according to the invention have been disclosed. These embodiments are illustrative of, and not limiting on, the invention. Other embodiments, as well as various modifications and combinations of the disclosed embodiments, are possible and within the scope of the disclosure.

What is claimed is:

1. A method of defining a three-dimensional surface of a compensator, the compensator for use in a radiation therapy machine to treat a cancer patient, the method comprising:
obtaining a radiation dose requirement created by a treatment planning system associated with the radiation therapy machine;
determining a plurality of grid elements based on the radiation dose requirement;
identifying a plurality of points on each of the plurality of grid elements; and
connecting at least one of the plurality of points on each of the plurality of grid elements with at least one of the plurality of points on another one of the plurality of grid elements to form a representation of the three-dimensional surface of the compensator.

2. The method of claim 1 wherein the step of obtaining the radiation dose requirement comprises obtaining a fluence file created by the treatment planning system.

3. The method of claim 1 wherein the identifying step comprises identifying four points one each of the plurality of grid elements.

4. The method of claim 1 further comprising applying a smoothing algorithm to the representation.

5. The method of claim 1 further comprising producing the compensator with the three-dimensional surface based on the representation.

6. The method of claim 5 wherein the producing step comprises providing the representation to a computer-aided design and manufacturing system which controls a machine tool to machine the compensator with the three-dimensional surface.

7. The method of claim 5 wherein the producing step comprises providing the representation to a computer-aided design and manufacturing system which controls a three-dimensional printing system to make the compensator with the three-dimensional surface.

8. The method of claim 5 wherein the compensator is used in intensity modulated radiation therapy (IMRT), proton radiation therapy, or cobalt radiation therapy.

9. The method of claim 1 wherein the representation of the three-dimensional surface of the compensator is a negative impression of the three-dimensional surface of the compensator.

10. The method of claim 9 wherein the negative impression of the three-dimensional surface of the compensator is used to produce a receptacle for receiving radiation-attenuating solid particulates.

11. The method of claim 10 wherein the radiation-attenuating solid particulates are crystalline tungsten powder.

12. The method of claim 1 wherein the representation of the three-dimensional surface of the compensator is a positive impression of the three-dimensional surface of the compensator.

13. The method of claim 12 wherein the positive impression of the three-dimensional surface of the compensator is used to produce the compensator with the three-dimensional surface from a solid piece of radiation-attenuating material.

14. The method of claim 13 wherein the solid piece of radiation-attenuating material comprises a solid piece of tungsten, aluminum, brass, machinable wax, or low-density polymer-based resin material such as polycarbonate.
